(19) United States
(12) Patent Application Publication
(10) Pub. No.: US 2007/0130508 A1
(43) Pub. Date: Jun. 7, 2007

(54) Hardware device with stylesheet for creating pictorial representation of device

(76) Inventor: Nigel James Gibbins, East Sussex (GB)

Correspondence Address: THE BOC GROUP, INC., 575 MOUNTAIN AVENUE, MURRAY HILL, NJ, 07974-2064, US

(21) Appl. No.: 10/576,007

(22) PCT Filed: Oct. 13, 2004
(86) PCT No.: PCT/GB04/04357

§ 371 Date: Apr. 14, 2006

(30) Foreign Application Priority Data
Oct. 14, 2003 (GB) 0324073.6

(51) Int. Cl. G06F 17/00; G06F 11/00

(52) U.S. Cl. 715/513; 702/188

(57) ABSTRACT

A manufacturing or service installation has a number of hardware devices for performing tasks. At least one such device has a computer or other means (14) for generating and reporting status data to a central computer (10) indicative of a status of the device or the installation. A memory associated with the device has a stylesheet for creating a pictorial representation of the device, whereby the central computer can access the stylesheet as well as the status data from the device, to create the pictorial representation and to populate the pictorial representation with the status data.

### FIELD OF THE INVENTION

This invention relates to hardware device which is to form part of an installation such as a manufacturing or service installation.

### BACKGROUND TO THE INVENTION

Modern manufacturing installations such as semiconductor plants have an increasingly complex array of sub-systems requiring monitoring, control, service and maintenance. For example, a semiconductor manufacturing plant has vacuum and abatement sub-systems as well as cryogenic systems and ultra-high-purity gas delivery systems. Other manufacturing plants have conveyor systems with staged production equipment (component insertion tools, soldering equipment, presses, ovens and the like). Similarly, service installations such as water or gas supply systems, irrigation systems and sewerage systems have pumps, valves, reservoirs and the like. Installations such as these have an increasing capacity to generate parameters and data such as flow parameters, temperature, pressure, alarms, status, electrical parameters and the like. Many of these are used locally at the installation for control of the installation. Others, such as alarms need to be reported with greater or lesser urgency to appropriate personnel, such as maintenance engineers.

Current installation monitoring equipment provides the ability to encapsulate an alarm message into a paging message of a radio-paging system and send the alarm message to a predefined pager address. A technician carrying the pager having that address receives the alarm and may be able to view some basic encapsulated information regarding the nature of the alarm, and is thus able to appropriately respond and give attention to any maintenance that may be required. Similarly, such a message can be encapsulated into an e-mail message and sent to an e-mail address or into a cellular radio short message service (SMS) message and sent to a cellular telephone. These arrangements all use private end-to-end delivery systems to deliver the specific message to the specific address. They are limited in their flexibility. For example, pagers and other such devices are useful for service technicians who need to respond to specific events, but they are limited in their ability to deliver any data other than a simple text message.

Personnel running and managing a large installation such as a manufacturing plant or service facility require a complete overview of all the parameters generated by the system. Supervisory control and acquisition of data (SCADA) systems provide this detailed level of information and are very flexible and can be programmed by the operator to display such information in a variety of ways. However, where the user requiring the information is not located at the installation, he or she may be unfamiliar with the equipment, particularly its physical layout and characteristics, or may be unable to program the SCADA system to deliver information in a form meaningful to the user. Even the operator of the SCADA system should, as far as possible, be relieved of the burden of reprogramming the system to deliver information in a more meaningful format. For example, the manufacturer of an individual hardware device (e.g. a pump, a Exhaust Gas Management System, a tank or any such device) is in a more advantageous position to know how best to present the information relevant to that device. If a new device is installed on the system it is inconvenient for the operator of the SCADA system to have to reprogram the system to present the new data delivered by the new device. Equally, if an existing piece of equipment is changed or upgraded it may be convenient (even if not necessary) to present the data in a manner that is more meaningful to the upgraded device.

Stylesheets, such as XML and XSL stylesheets, provide a manner of defining presentation of data separated from the data to be presented. For example “Creating a Customizable Management Application” by H. Wolff of Art & Logic (available at www.artlogic.com/embedded/we/articles_customize.html) describes JavaScript and Cascading Style Sheets, but without reference to how or where to provide such stylesheets in an installation or item of equipment and without reference or suggestion as to the difficulties or shortcomings in providing a single stylesheet to accommodate a complex or integrated piece of equipment.

There is a need for a more flexible manner of presentation of data in such installations.

### SUMMARY OF THE INVENTION

According to a first aspect of the present invention, a hardware device is provided for performing a task in an installation, the device having means for generating and reporting status data to a computer indicative of a status of the device or the installation. The device may be almost any active or passive element of an installation, such as a pump, a Exhaust Gas Management System, a flow valve, a tank, a press, an oven, a conveyor, etc. The means for generating and recording status data is preferably a computer connected to the device. The device is characterised by having a memory (e.g. in its associated computer) having stored therein a stylesheet for creating a pictorial representation of the device, whereby the computer (e.g. a SCADA computer or a remote computer) can access the stylesheet as well as the status data from the device, to create the pictorial representation and to populate the pictorial representation with the status data. The memory may be an element of the hardware device, or may be a separate data carrier such as a compact disc for loading the stylesheet into a computer connected to the hardware device.

In a second aspect of the invention, the hardware device as described above is provided in combination with a computer, such as a SCADA computer or a web server, for receiving the stylesheet from the hardware device to enable the computer to create the pictorial representation of the hardware device populated with the status data. The pictorial representation may be displayed locally to the computer on a monitor, or may be delivered by the computer operating as a web server to another, more remote, computer where it can be displayed, for example as a web page.

In accordance with a further aspect of the invention, a computer, such as a SCADA computer or a general purpose computer having an Internet or Intranet connection, is provided for receiving a stylesheet from the hardware device described above to create the pictorial representation of the hardware device, populated with the status data. The computer has means for analysing the status data to create derived status data, and means for further populating the stylesheet with the derived status data.

In this manner, pictorial representations and/or stylesheets can be gathered from different hardware devices and assembled at the computer in a rich and meaningful representation of the entire installation or parts thereof. In this manner, a composite stylesheet for a single or complex item of equipment can be built up from separate stylesheets.

In accordance with a further aspect of the invention, a manufacturing or service installation is provided comprising a plurality of hardware devices as described above, each having sensing means for sensing an operating parameter and for reporting status data to a computer indicative of a status of the installation, and a computer connected to the hardware devices for receiving and storing stylesheets and status data from the hardware devices and creating a composite pictorial representation of the plurality of hardware devices and populating the composite pictorial representation with the status data. A still further aspect of the invention provides a server for connecting to equipment to be monitored, the server having an Internet Protocol (IP) address and comprising a database for receiving and storing data from the equipment, and means for communicating, to a remote application addressing the server by its IP address, data representative of a current status of the equipment and a stylesheet representative of the equipment independent of the status. In this manner, a pictorial representation of the equipment can be generated at the remote application from the stylesheet and the pictorial representation can be populated with data representing the current status of the equipment.

A further aspect of the invention provides for a computer for connecting to the server described above, the computer comprising: means for accessing such a server; means for receiving therefrom and storing a stylesheet representation of equipment defining a web page and status data representative of a current status of the equipment, for populating that file; and means for communicating the file, populated with the status data, to a remote computer.

Other aspects of the invention in the form of methods and computer programs are defined in the claims.

A preferred embodiment of the invention is now described, by way of example only, with reference to the drawings.

### DETAILED DESCRIPTION OF THE DRAWINGS

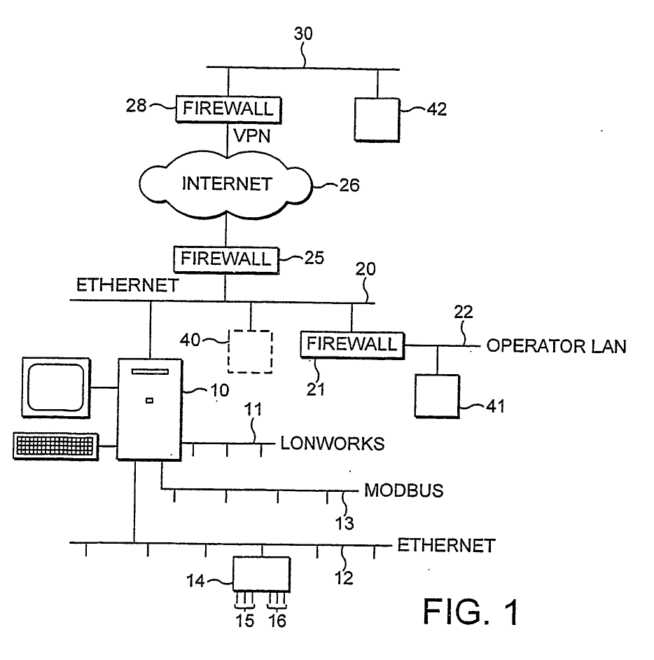

FIG. 1 is an overall block diagram of an installation such as a semiconductor manufacturing plant, connected via the Internet to the offices of a service provider such as a maintenance company.

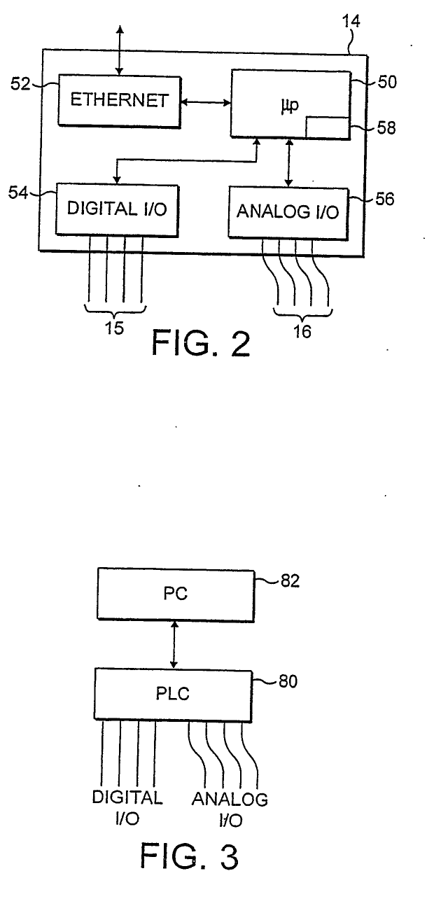

FIGS. 2 and 3 illustrate details of different examples of a processor of FIG. 1 that is connected to the equipment being monitored.

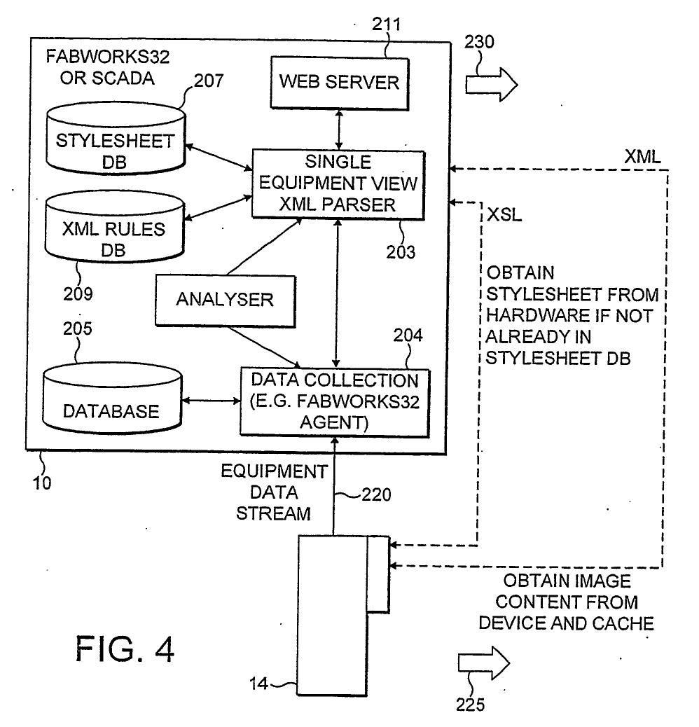

FIG. 4 is a schematic representation of the central processor of FIG. 1 set out in greater detail.

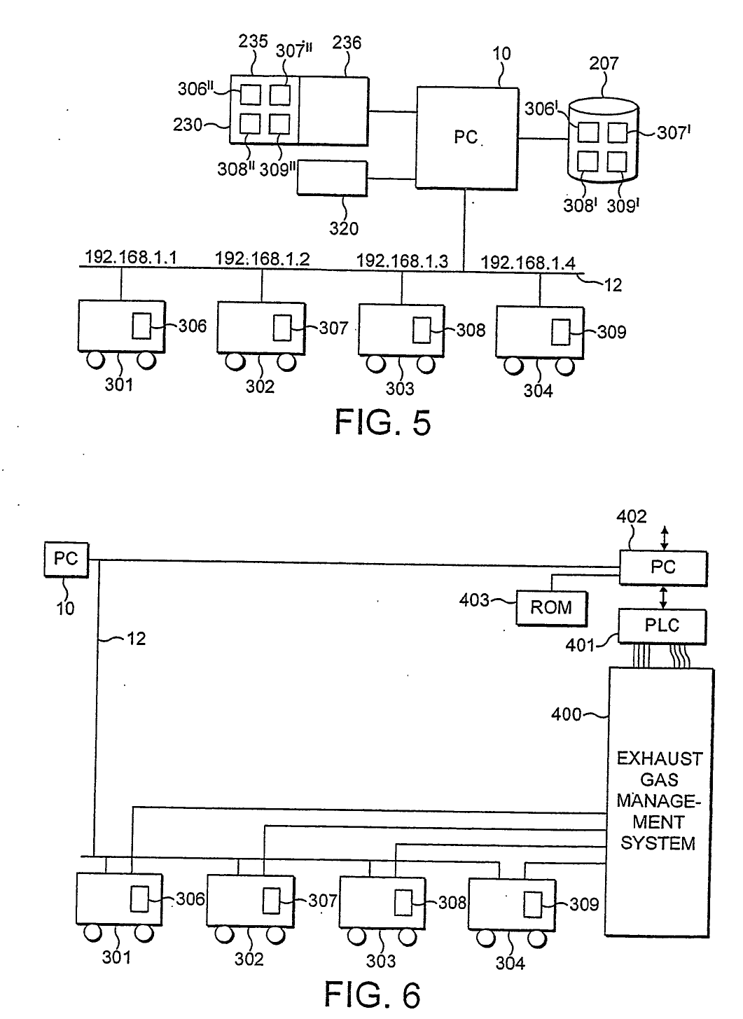

FIG. 5 illustrates elements of the system of FIG. 1 with examples of hardware devices in an illustrative installation.

FIG. 6 is a further example, similar to that of FIG. 5, with additional equipment in the installation.

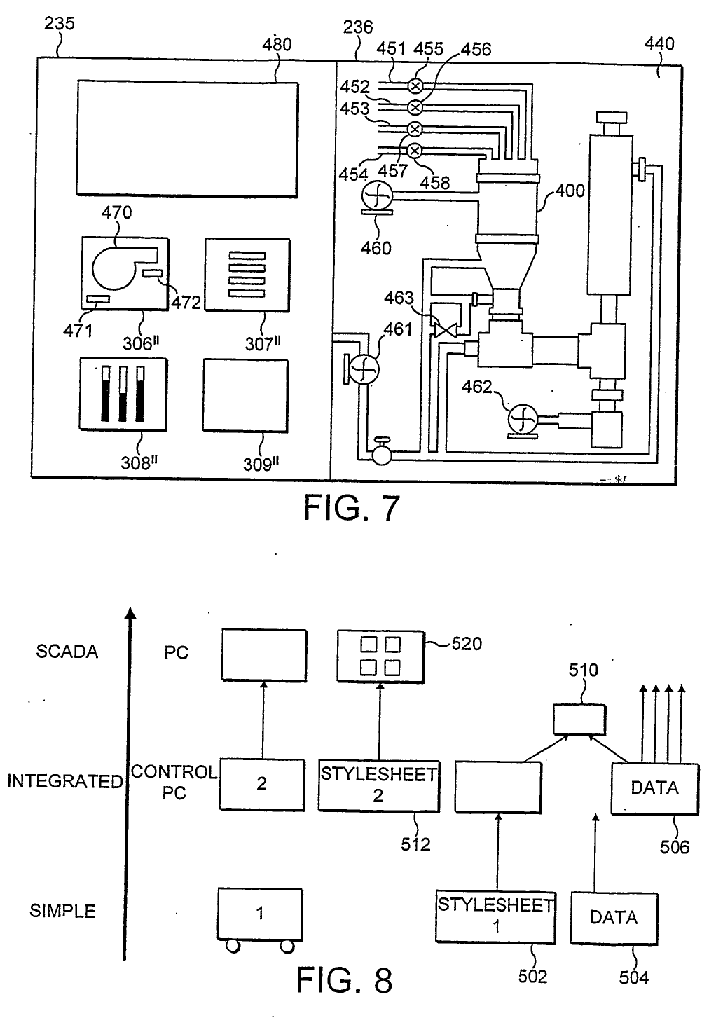

FIG. 7 is an illustration of a web page or other screen image from the examples of FIGS. 5 and 6, shown in greater detail.

FIG. 8 is a schematic illustration of the manner in which an installation with its computers and stylesheets in accordance with the invention can be organised in a hierarchical manner.

### DETAILED DESCRIPTION OF THE PREFERRED EMBODIMENT

An installation such as a semiconductor plant or other manufacturing plant or indeed a service installation such as a water irrigation system has many sensors and measuring devices measuring, for different stages along the manufacturing process, parameters such as fluid and gas flow, temperature, pressure, fluid level, alarms, status, chemical sensor data, vibration, noise, electrical parameters and times of events. For each stage in a process, for example at a pump or a Exhaust Gas Management System, there can be a series of digital signals and analog signals which need to be input into a supervisory control and data acquisition (SCADA) system.

FIG. 1 shows a SCADA system comprising a central processor 10 having one or more local area networks (LANs) 11, 12 and 13 connected to a number of items of equipment in the process via processors 14. In the example shown, LAN 11 is a proprietary LonWorks (trademark) bus, LAN 12 is an Ethernet bus, and LAN 13 is of the MODBUS type. Connected to LAN 12 is a processor 14 having digital inputs 15 and analog inputs 16, which are all connected to sensors and measuring devices in the equipment to be monitored. A number of other processors (not shown) the same as processor 14 are connected to the various buses for the same purpose. The processor 14 typically has a programmable system to gather the various signals from the equipment being monitored and convert them into a protocol suitable for the particular bus (11, 12 or 13) connected to the central processor 10. Alternatively, particularly in the case of a processor connected to the Ethernet LAN 12, the processor 14 may itself be a server.

A further LAN 20 is connected to the central processor 10 for the purpose of communicating with operators and maintenance personnel. The LAN 20 is connected by a firewall 21 to a LAN 22, here referred to as an operator LAN, being the internal network of the operator of the installation. The LAN 20 is also connected through a further firewall 25 to the Internet 26 and via the Internet through a further firewall 28 to the LAN 30 of a service provider such as a maintenance service provider providing maintenance services to the installation. The LAN 20 between the firewalls 21 and 25 is typically known as a DMZ (demilitarised zone), being less secure than the operator LAN 22.

Various other servers and computers can be connected to the various LANs. In particular, an optional server 40 is shown connected to the Ethernet LAN 20, a computer 41 is shown connected to the operator LAN 22 and a further computer 42 is shown connected to the LAN 30. Computers 41 and 42 may be servers for serving web pages to other computers connect to the respective LANs 22 and 30.

In operation, equipment being monitored generates digital and analog signals and interrupts which are received by the inputs 15 and 16 of the processor 14. Some or all of this data and these signals need to be communicated to a maintenance engineer who is not necessarily located at the same site or to the same local area network.

In prior art arrangements, it has been known to use these signals to present tables and charts to a technician using one of servers 41 and 42. The presentation of the data is in a format determined at the computer 41 or 42, e.g. in the form of a pre-designed web page. Such an arrangement is inflexible and imperfect for a number of reasons. The manner in which the data is presented to the user needs to be to a certain degree generic, so that data from different types or versions of equipment (including possible future versions) can all be presented is a common form. This is not ideal, as users would find the data to be more meaningful if presented in a manner specific to the equipment being monitored. If the equipment in which processor 14 is incorporated is changed (e.g. is upgraded), the data presented to the user can be up-to-date, but the user may be unfamiliar with the new equipment and may be unfamiliar or confused by the way the data is presented. Any other presentation of the data needs to be programmed at computer 41 or 42, which is not an easy task, especially if the computer 41 or 42 is remote from the equipment or if the technician at that computer is unfamiliar with the equipment.

Accordingly, in the preferred embodiment of the invention, the computer 14 has a pre-stored stylesheet that defines the manner in which data reported by the computer 14 is to be presented. In particular, the stylesheet defines a pictorial representation of the equipment of which the computer 14 is a part, showing at least the relative physical locations of the digital and analog inputs and outputs 15 and 16 and the topological paths in the equipment that relate these inputs and outputs to each other. This stylesheet is sent to or is readable by processor 10 operating as a server and can be picked up by remote computers such as computers 41 and 42.

According to a particularly preferred feature of the described embodiment, a number of stylesheets from different computers (such as computer 14) are assembled together at the central processor 10 into a high-level composite stylesheet that is sent to or is readable by computers 41 and 42. I.e. the stylesheet supplied by computer 14 is a sub-part of a larger stylesheet put together by computer 10. The stylesheets are assembled together by computer 10 in the same manner as a webpage is assembled. When a webpage is assembled, a frame or structure is defined, and pictures and other components are looked up and placed in the appropriate positions in the frame or structure. Similarly, the composite style-sheet looks to the computer 14 (and other computers) to deliver the components of the composite stylesheet. The information about where to look to find the elements of the composite stylesheet is stored in the composite stylesheet at central computer 10. Thus, if the equipment of which computer 14 is a part is changed and a different computer 14 is put in place with a different stylesheet, the operation is unchanged. All that changes is that the part of the composite stylesheet delivered by computer 14 to central computer 10 will change. As the stylesheet delivered by computer 14 is provided by the manufacturer of the equipment (of which computer 14 is a part), if the equipment is upgraded the stylesheet can also be upgraded, and the user using the computer 41 or 42 will observe data displayed in a format dictated by the updated stylesheet, in particular with graphical representations of the equipment that are customised to the new equipment.

The arrangement described has a further advantage in terms of performance. By separating the stylesheet from the data, the stylesheet can be sent just once to the computer reading the data, after which the data can be updated as required. This is more efficient in terms of utilization of network resources than is the case if richly formatted data needs to be sent whenever it is updated.

How these arrangements are achieved is described now in greater detail.

FIG. 2 shows an example arrangement for the computer 14. It comprises a microprocessor 50 connected to an Ethernet interface 52, a digital input/output device 54 and an analog input/output device 56. The Ethernet interface 52 is connected to the Ethernet bus 12.

Parameters sensed or input at the digital inputs 15 are received by digital I/O device 54 and passed to the microprocessor 50. Analog signals received on inputs 16 are digitised in analog I/O device 56 and their digital values are passed to microprocessor 50. The inputs 15 and 16 are connected to installation equipment such as a pump, a Exhaust Gas Management System, a valve or any one of a number of different and varied elements in a manufacturing or service installation. Stored in memory 58 associated with the microprocessor 50 is an XSL stylesheet, which will define the manner in which data from the inputs 15 and 16 will ultimately be presented. The stylesheet 58 preferably includes a graphical image of the equipment that is connected to the inputs 15 and 16.

In operation (preferably in a pre-operational system set-up mode), the stylesheet 58 is retrieved from the microprocessor 50 through the Ethernet interface 52 upon the request of an external computer connected to the Ethernet bus 12. The external computer (e.g. computer 10) retrieves the stylesheet by addressing the individual IP address of the computer 14 and by addressing the XSL stylesheet stored in memory 58 by a predetermined file name.

Referring to FIG. 3, and an alternative arrangement to that of FIG. 2 is shown, in which the analog and digital I/O devices are replaced with a programmable logic controller 80 which is connected to a personal computer 82. In this case, the XSL stylesheet is located in memory in the personal computer 82 (e.g. having been loaded into that computer from a CD-ROM or other medium).

Referring to FIG. 4, the central processor 10 is illustrated in greater detail and is shown coupled to the processor 14. The central processor 10 comprises a data collection agent 201, an example of which is a FabWorks 32 (trademark) agent. Connected to the data collection agent 201 is an XML parser 203 and a first database 205. Connected to the parser 203 is a stylesheet database 207, a rules database 209 and a web server 211. An optional analyser software module 206 is shown connected between data collection agent 201 and parser 203.

In operation, the web server 211 will serve an HTML or ASP web page which is made up of device data and a template derived from an XSL stylesheet. For example, the stylesheet may define fields for parameters such as cumulative run time, run time to service, gate valve, water flow sensor, seals purge solenoid, gas ballast and inlet purge for a given drive pump and a given booster setting. For such a template, data is required, such as the actual cumulative run time and the run time to service etc and the on/off status of the seals purge solenoid, the gas ballast and the inlet purge. To create this web page, the web server 211 receives the template format from the single equipment view XML parser 203, which receives the format definition from the stylesheet database 207 and passes this according to XML rules stored in the rules database 209. If there is not already a stylesheet for a given element of hardware stored in the stylesheet database 207, the stylesheet is obtained from the hardware computer 14 (from the memory 58 therein) and this is stored in the stylesheet database 207 for present and future use. The parser 203 receives the data to populate the fields of the web page from the data collection agent 201. This agent receives data from its database 205 and also updates the data in the database 205 using a datastream 220 that is continuously received from the computer 14.

The data produced/required to be stored on central processor 10 (and any other web-serving system or sub-system in the installation) is as follows:
Live Data—the data that represents the current state of the system and any attached sub-systems
Historical Data—archived “Live Data” stored covering a defined period from the local system and any attached sub-system
Events Data—Alarms, warnings and other defined events from the local system and any attached sub-system
Snap-Shot Data—“Live Data” that was being held at the time of a recorded “Event Data” item.
News Feed—A collection of advisories that new “Events Data” items have occurred.

The data model uses an XML data structure, XLS stylesheets and web-pages that use these files to present the data to the user and/or data recording system. These are briefly explained here.

XML Files

All “Live Data”, Historical Data”, Events Data” and “Snap-Shot Data” is stored in XML structured files. Any event, be that a warning, alarm or other event (as defined by the user/designer) will cause:

The creation of a “Snap-Shot” Data file that will hold the “Live Data” recorded at the time of the defined event

The creation of a “News Feed” Rich Site Summary (RSS) file and/or News Syndication Javascript, VBScript (or equivalent) file (see “script files” below). These will point the user to the relevant file that will allow them to view both the current “Live Data” and the “Snap-Shot Data” of the relevant event.

XLS Files

These define the way to present the XML data of the local web-server. Effectively they serve as a template of the pictorial representation of the device in question. They can also be used to allow a higher level system to present the data recorded from a sub-system in the same manner as viewed directly on that sub-system. See Appendix B for the background to XLS Transformations.

ASP/HTML (etc) Files

These files are used to present the XML data rendered in the format defined by the XLS file. XML data obtained from sub-systems can be presented using sub-system XLS files or alternative local XLS files used as preferred. Data can be presented to the user by either client or server side processing. Server side can produce code that is virtually browser independent.

Script Files

An example of a script files is a VBScript or Javascript file that can be read as an include file by another system to advise the reader of the relevant web-page that a event has occurred on a monitored system.

As well as the stylesheet obtained from the computer 14, image content can be retrieved by the central processor 10 from the computer 14. This image content is in the form of a pictorial representation of the equipment connected to computer 14 (the pump, Exhaust Gas Management System or other element or assembly of elements). This pictorial representation forms an additional element of the web page to be served by web server 211. The location of this image content is defined by the stylesheet for the particular device (i.e. the stylesheet originating from computer 14). The image content is one element (along with the data) that populates the template defined by the stylesheet. The image content is delivered in XML format.

Software applications that have the capability to work with XML documents occasionally need to display or structure the data in a format different from that specified in the document. If the only method for accomplishing this task necessitates programmatically transforming the XML document into the appropriate format by using an XML parser paired with a programming language, the power of having a cross-platform and language-independent XML language would be lost. Some method of transforming XML documents into different formats such as HTML, flat files, Wireless Markup Language (WML), and even other forms of XML is required so that it can be used on any platform and with any language. Extensible Stylesheet Language Transformations (XSLT) accommodates this need and these transformations are now described in greater detail. Many XML parsers now provide full XSLT support.

Of interest in the preferred embodiment of the present invention is the capability of XSLT to transform XML documents into different formats that can be consumed by a variety of devices, including browsers, Personal Digital Assistants (PDAs), Web-enabled phones, and indeed other devices. Transformations can also be useful in situations where an XML document's structure does not match up well with an application that will accept the data within the document. An XML document may contain the appropriate data to be imported into a database, for example, but may not be structured in a way that the application performing the import expects.

The process of transforming an XML document into another format, such as HTML or WML, relies on two types of processing engines. First, a parser 203 is provided, which is capable of loading an XML document to load the source code. Next, an Extensible Stylesheet Language Transformation (XSLT) document is loaded and a tree structure is created for it. This tree structure is optimised to accommodate XSLT processing and is specific to the processor being used. An XSLT processor then takes the XML document structure, matches up nodes within the document against “templates” found in the XSLT document (described below), and then outputs the resulting document. The third tree structure (the resulting document) is dynamically created based on information contained in the XSLT document.

XSLT relies on templates to process and create a particular output structure. A stylesheet contains a set of template rules. A template rule has two parts: a pattern which is matched against nodes in the source tree, and a template which can be instantiated to form part of the result tree. This allows a stylesheet to be applicable to a wide class of documents that have similar source tree structures.

Templates provide a basic structure that can be reused for specific purposes. For example report can be generated from a template where the template has specific form fields built in so that every report generated looks the same. Templates in XSLT is arranged to match up with nodes in an XML document. XSLT templates provide a way to process and structure data contained within elements and attributes in the source XML document. They provide a template structure that can be processed when a particular node in the source XML document is discovered.

The XSLT processor described earlier is provided with two tree structures to walk through. The first is the structure for the source XML document and the second is the XSLT document itself. After these two structures are provided, the XSLT processor attempts to match element or attribute names found in the XML document with templates contained in the XSLT tree structure. This matching process uses XPath expressions that are embedded within the XSLT document. When a node found within the XML document matches a template in the XSLT document, that template is processed.

Processing of templates found within an XSLT document normally starts with a template that matches the root node of the XML document and proceeds down to its children. When a template is processed, the output is added to the third tree structure mentioned earlier that is used in building the output document.

Templates permit processing of a variety of XML document structures and are very efficient in cases where an XML document contains repetitive items. Each time an element, attribute, text node, and so on is found, it is matched up with the appropriate template via XPath expressions. If a given node does not have a matching template, no processing will occur on it, and the next section of the XML document is processed. In cases where a matching node is found, the template takes care of generating the proper output structure based on data/nodes contained within the node.

The central processor 10 may add its own data to the web page 230 created by the web server 211, for example using analyser software module 206. This software module performs trend analysis on a given data stream. For example it performs rolling average (integration) analysis or looks for unusual spikes (differentiation) in the data. It can also analyse various incoming datastreams coming from separate items of equipment. For example it can compare one stream of parameters with another stream of parameters and look for correlations or anomalies. It can measure flow into a given stage and compare it with flow out and search for discrepancies indicative of leakage. These are just examples of the many analysis functions that can be performed.

Analysis software 206 is shown as delivering its results (derived data) to parser 203 (although, of course, it can return its results to database 205) to combine with or substitute for status data from the equipment 14 in order to populate the web page delivered by the web server 211 in accordance with the stylesheet. If necessary the stylesheet is automatically modified locally to accommodate the derived data.

In this way, the computer 14 can deliver a web page 225 over the Ethernet bus 12 that represents the data specific to the equipment coupled to the computer 14, in a manner defined (partially, if not totally) by the stylesheet stored therein and using graphical images of that equipment, also stored at the computer 14. Additionally, the central computer 10 can deliver a web page 230 that shows the same level of information as the web page 225, but shows additional information or images, including data generated by the central processor 10 by analysis of the incoming datastream or streams and including additional pictorial representations received from additional computers connected to the Ethernet bus 12. These features are further illustrated in FIG. 5.

FIG. 5 shows a first pump 301 and three other pumps 302, 303 and 304, each having a computer (as described with reference to computer 14) connected to the Ethernet bus 12. It is illustrated that each of these computers has an individual and unique IP address. These addresses are, byway of example only, given as 192.168.1.1 to 192.168.1.4. Each of the computers within the pumps 301 to 304 has a memory 306 to 309, each containing a stylesheet and a pictorial representation (in XML format) of the pump. The central processor 10 retrieves these stylesheets and these pictorial representations and stores copies of them (306′ to 309′) in the stylesheet database 207.

In operation, the central processor 10 generates a web page having a first portion 235 and a second portion 236, where the first portion 235 has windows 306″ to 309″, each being defined by its corresponding stylesheet stored in stylesheet database 207. The layout of the web page 230 and the relative positions of various windows 306″ to 309″ are defined in set-up file 320. The second portion 236 of the web page can contain other data, the presentation of which is defined by one or more other stylesheets (e.g. data from a Exhaust Gas Management System to which all the pumps 301 to 304 are connected).

Various stylesheets from various pumps or other items of equipment and their associated image data can be assembled in a hierarchical manner in the central processor 10, as is now described with reference to FIG. 6. In that Figure, the pumps 301 to 304 are shown physically and electrically connected to a Exhaust Gas Management System 400 having its own PLC 401, PC 402 and memory 403. Stored in memory 403 is a stylesheet and a pictorial representation of the Exhaust Gas Management System 400. The stylesheet within the memory of the PC 402 defines windows for other fields into which sub-images and representations (as defined by the sub-element stylesheets 306 to 309) are inserted. Thus, when the central processor 10 calls for the stylesheet from PC 402, it inherently also calls for the sub-stylesheets from all the elements referenced by the stylesheet in PC 402.

FIG. 7 shows the web page 230 of FIG. 5 as it may appear in the case of the system of FIG. 6. FIG. 7 shows that the right-hand portion 236 of the web page is filled with an image 440 of the Exhaust Gas Management System 400. The image shows various pipes and valves in their actual physical configuration. The image is not necessarily to scale (although is preferably to scale) and may be stylised, but at least sets out the various topological configurations and connections between the elements of the installation, in particular the elements of hardware and the devices that provide data to the digital and analog connections 15 and 16 of computers such as computer 14.

The image 440 shows various pipes 451 to 454, each having a corresponding valve 455 to 458, all connected to the output of the Exhaust Gas Management System 400. It also shows various other valves 460 to 463 connected to other inlets and outlets of the Exhaust Gas Management System 400. The image 440 may be a .GIF or .TIF or .JPEG or .PDF file or other image file retrieved from memory 403.

In the lefthand section 235 of the web page, further images are inserted (as described above) in windows 306″ to 309″, illustrating each of the pumps 301 to 304. These may take a number of forms. By way of example, the image in window 306″ is shown as having an image 470 of a pump, with fields 471 and 472 in which data appears showing values (e.g. input and output pressures) of the pump. The image in window 307″ shows an arrangement of fields or boxes in which data appears, and the image in window 308″ shows graphical elements in the form of images of linear gauges representing similar information in a graphical form.

Other fields or graphical representations of data can be superimposed upon image 440 in the righthand section of the web page to show parameters of the Exhaust Gas Management System and to show the locations of the measuring points for those parameters. Alternatively, or in addition, parameters for the Exhaust Gas Management System 400 can be displayed in window 480 on the lefthand side.

“Live Data”, Historical Data” and “Events Data” files will consist of locally generated data items plus data recorded from similar files on associated sub-systems either stored as “child” items within the XML structure of a single file (direct) or stored as separate file copies of the sub-system files (indirect). Note that a subsystem may be a child of more than one system. So, for example, the “Events Data” file(s) of a given system (e.g. PC 402 and its associated Exhaust Gas Management System) will also directly or indirectly hold the “Events Data” files of sub-systems at a level below (e.g. pumps 306-309). There may also be occasions where a sub-system is shared—in this case it could be that all of the data from a given sub-system is added to the files of the system above or it may be the case that only an appropriate sub-set is added.

Further hierarchical layers can be built up as shown in FIG. 8. In this Figure, a simple layer at the lowest level is shown (e.g. at the level of the pumps 301 to 304), an integrated level above this is shown (e.g. at the level of the Exhaust Gas Management System 400) and a supervisory control and acquisition of data (SCADA) level is shown, for example at the level of the central processor 10. A stylesheet 502 and its associated data 504 from the simple level is passed up to the integrated level, where the style sheet 502 is integrated with its data 504 at a control PC. Further data 506 at the control PC level can be integrated to form a complete XML (or HTML) document 510. Additionally, the data 506 can be passed up to the SCADA level at the central processor 10 and together with further stylesheets 512 (and the stylesheet 502) an integrated stylesheet 520 can be created, which can be populated with data collected from various data streams. At each level images from that level or images from a level below, can be assembled together into an integrated image showing the entire installation or assembly of equipment. The images can be complete for all elements of equipment in the domain and can be as detailed as the equipment at the lowest level.

In the manner described, any device in isolation can present its data (pushed or polled) in a defined format (e.g. XML) and can pass the information to a supervising monitoring system that describes the way to present that data to the outside world. The monitoring software (e.g. in a SCADA system) can read XSL files from other elements of equipment in the system and use it or them to locally present the pictorial representation of the device from which the file is read with the same layout as presented by the device itself. Monitoring software can add its own data to that presented by the local device and still maintain the same format as that from the originating device. For example, the SCADA equipment can add alarms and events that only it knows about. It can add these alarms and events to the list of data items presented by the lower level device.

The control hierarchy allows presentation of sub-device data in a structured consistent way, no matter whether the operator is viewing the system directly or at a high level within the monitoring software structure. The data structure also allows the system-to-multiple sub-system hierarchy to be maintained in the data structures. Users can easily design their own viewers based on existing styles and layouts presented by the devices in the system.

Using this hierarchical structure, the data generated by a device (such as a pump) is presented in XML format and the pictorial representation of that device is defined within the XSL file. The latter XSL file effectively becomes a “template” of what the device should look like on a monitoring PC screen. The device may be a sub-part of another device (e.g. a pump could be part of an integrated abatement system). The XSL template of the device (e.g. pump) can be used to define the appearance of the device on the display of the integrated system. In turn a monitoring Supervisory, Control and Data Acquisition system (SCADA) can use the XSL template(s) from the integrated devices or individual devices to represent their appearance on the SCADA monitoring screens. Further the monitoring device can add to the data presented on the XSL template. So for example, if the monitoring device determines (by e.g. data analysis) that a fault has occurred it can add that fault to the alarms and events page presented by the device on which the error/problem has occurred.

1. A hardware device for performing a task in an installation, comprising means for generating and reporting status data indicative of a status of the device or the installation; a memory for storing a stylesheet for creating a pictorial representation of the device so that a computer can access the stylesheet and the status data, to create the pictorial representation of the device and to populate the pictorial representation of the device with the status data.

2. The hardware device according to claim 19 further comprising a computer for receiving the stylesheet to create the pictorial representation of the hardware device and to populate the pictorial representation with the status data.

3. The hardware device according to claim 2 wherein the computer for receiving the stylesheet is arranged as an Internet/Intranet web server for delivering the pictorial representation to a remote computer for display at the remote computer.

4. The hardware device according to claim 2 wherein the computer includes means for analysing the status data to create derived status data; and for populating the stylesheet with the derived status data.

5. The hardware device according to claim 4 wherein the means for analysing the status data comprises a data trend analysis software module.

6. The hardware device according to claim 4 wherein the computer for receiving the stylesheet to create the pictorial representation of the hardware device and to populate the pictorial representation with the status data comprises a plurality of computers for receiving status data from corresponding ones of a plurality of hardware devices, said plurality of computers having different Internet Protocol addresses, and wherein the means for analysing the status data comprises a comparison of the status data from the corresponding ones of the plurality of hardware devices.

7. The hardware device according to claim 4 further comprising means for modifying the stylesheet to accommodate the derived status data.

8. The hardware device according to claim 3 wherein the status data is in extensible mark-up language (XML) and the stylesheet is in extensible stylesheet language (XSL).

9. A manufacturing or service installation comprising a plurality of hardware devices according to claim 1 at least two of the plurality of hardware devices having sensing means for sensing an operating parameter and for reporting status data indicative of a status of the installation, and a computer connected to the at least two of the plurality of hardware devices for receiving and storing stylesheets and status data from the at least two of the plurality of hardware devices and for creating a composite pictorial representation of the plurality of hardware devices and populating the composite pictorial representation with the status data.

10. A server for connecting to equipment to be monitored, the server having an internet protocol (IP) address and comprising a database for receiving and storing data from the equipment, means for communicating to a remote application addressing the server by its IP address data representative of a current status of the equipment and a stylesheet representative of the equipment independent of status, so that at the remote application, a pictorial representation of the equipment can be generated from the stylesheet and the pictorial representation can be populated with data representing the current status of the equipment.

11. The server according to claim 10 further comprising an active server page file that interrogates the database to create a dynamic file that is accessible from the remote application.

12. A computer for connecting to server for connecting to equipment to be monitored, the server having an internet protocol (IP) address and comprising a database for receiving and storing data from the equipment, means for communicating to a remote application addressing the server by its IP address data representative of a current status of the equipment and a stylesheet representative of the equipment independent of status, so that at the remote application a pictorial representation of the equipment can be generated from the stylesheet and the pictorial representation can be populated with data representing the current status of the equipment and wherein the computer comprises:
means for accessing the server;
means for receiving from the server and storing (a) a stylesheet representation of the equipment defining a web file and (b) status data representative of a current status of the equipment for populating that file; and
means for communicating the file, populated with the status data, to a remote computer.

13. The computer according to claim 12 wherein the means for receiving are arranged to receive derived status data derived on the server by analysis of the status data received from the equipment and means for adding the derived status data to the status data displaying the derived status data and the status data together using the same stylesheet.

14. The computer according to claim 13 further comprising means for locally modifying the stylesheet to accommodate the status data and the derived status data.

15. A data carrier having stored thereon instructions and data for loading into a computer associated with a hardware device for performing a task in an installation, the instructions and data including a stylesheet representation of the hardware device, which, when loaded into the computer, enable the computer to generate and report status data to a remote computer indicative of a status of the device or the installation, and to generate a pictorial representation of the device, so that the stylesheet as well as the status data can be accessed from the hardware device and its associated computer, to create the pictorial representation at the remote computer and to populate the pictorial representation with the status data at that remote computer.

16. A method of operation of a manufacturing or service installation comprising:
providing at least one hardware device for performing a task in the installation, the device having means for generating and reporting status data to a computer indicative of a status of the device or the installation, characterized by a memory having stored therein a stylesheet for creating a pictorial representation of the device;
sensing an operating parameter in the hardware device and reporting status data to a computer indicative of a status of the device,
accessing the stylesheet as well as the status data by the computer from the device;
creating a pictorial representation of the device; and
populating the pictorial representation with the status data using the stylesheet.

17. The method according to claim 16 further comprising receiving and storing a plurality of stylesheets from a plurality of hardware devices, creating a composite pictorial representation of the plurality of hardware devices and populating the composite pictorial representation with the status data.

18. The hardware device as in claim 1 wherein the means for generating and recording is a computer.

19. The hardware device as in claim 18 wherein the computer includes the memory for storing a stylesheet for creating a pictorial representation of the device.
